(19) United States
(12) Patent Application Publication
(10) Pub. No.: US 2013/0154274 A1
(43) Pub. Date: Jun. 20, 2013

(54) SYSTEMS FOR ELECTRICAL POWER GENERATION

(71) Applicant: Robert Vincent, Stafford, VA (US)

(72) Inventor: Robert Vincent, Stafford, VA (US)

(21) Appl. No.: 13/467,420

(22) Filed: May 9, 2012

Related U.S. Application Data
(60) Provisional application No. 61/577,395, filed on Dec. 19, 2011.

(51) Int. Cl. H02K 7/18

(52) U.S. Cl. 290/1 A

(57) ABSTRACT

Systems for generating electricity from waste heat given off by an electrical system are disclosed. An electrical power generation system comprises a hollow tubular member closed at both end, a magnet disposed within the tubular member, a conducting coils disposed on an outside surface of the tubular member, a thermocouple adapted to accumulate a charge so as to induce movement of the magnet within the tubular member, and one or more circuit boxes electrically coupled to the conducting coils.

### BACKGROUND

Due to environmental and economic concerns, electrical energy is now in high demand. This has led to a proliferation of electrical engines and electrically powered devices. Many of these devices utilize highly efficient engines and power sources. However, waste heat is generally output by these devices. This occurs regardless of the efficiency of the system. Yet, if properly harnessed, the wasted heat output could be used to generate additional electricity.

Stirling engines may be run directly from any available heat source, such as solar, geothermal, biological, nuclear or waste heat, and thus may be used to recycle any waste heat from electrical systems. However, Stirling engines are typically too large and costly to justify their power output, as many Stirling engines are run from mechanical generators. Further, Stirling engines cannot automatically start, and typically require time to warm up. Thus, an electrical reclamation system which may automatically generate electricity from waste heat is desirable.

### SUMMARY

An electrical power generation system may generate electricity from waste heat given off by an electrical system. An electrical power generation system may a hollow tubular member closed at both end, a magnet disposed within the tubular member, a conducting coils disposed on an outside surface of the tubular member, a thermocouple adapted to accumulate a charge so as to induce movement of the magnet within the tubular member, and one or more circuit boxes electrically coupled to the conducting coils.

### BRIEF DESCRIPTION OF THE FIGURES

The present embodiments are illustrated by way of example and not limitation in the figures of the accompanying drawings, in which like references indicate similar elements.

FIG. 1a illustrates an exemplary embodiment of a power generation system.

FIG. 1b illustrates a cutaway view of an exemplary embodiment of a power generation system.

FIG. 2 illustrates another exemplary embodiment of a power generation system.

FIG. 3 illustrates an exemplary circuitry diagram of an autostart charger circuit.

FIG. 4 illustrates an exemplary circuitry diagram of an autostart accelerator circuit.

FIG. 5 illustrates an exemplary circuitry diagram of a power-generating circuit.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, a discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Embodiments disclosed herein describe power generation systems. The systems may generate electricity from waste heat, may employ the general principles of a Stirling engine, may be space-efficient, and may start automatically with minimum or no warm-up time. In one exemplary embodiment, as a temperature differential builds up, a sufficient resulting charge may cause a Stirling engine to begin to cycle and generate electricity.

The system may reduce the overall electricity demands of any systems or apparatuses powered by a particular electrical system, thereby reducing costs. The system may combine a Stirling engine with a linear magnet generator, such that electricity may be produced from waste heat. Further, a thermocouple may be utilized to automatically start a piston included within the system and device.

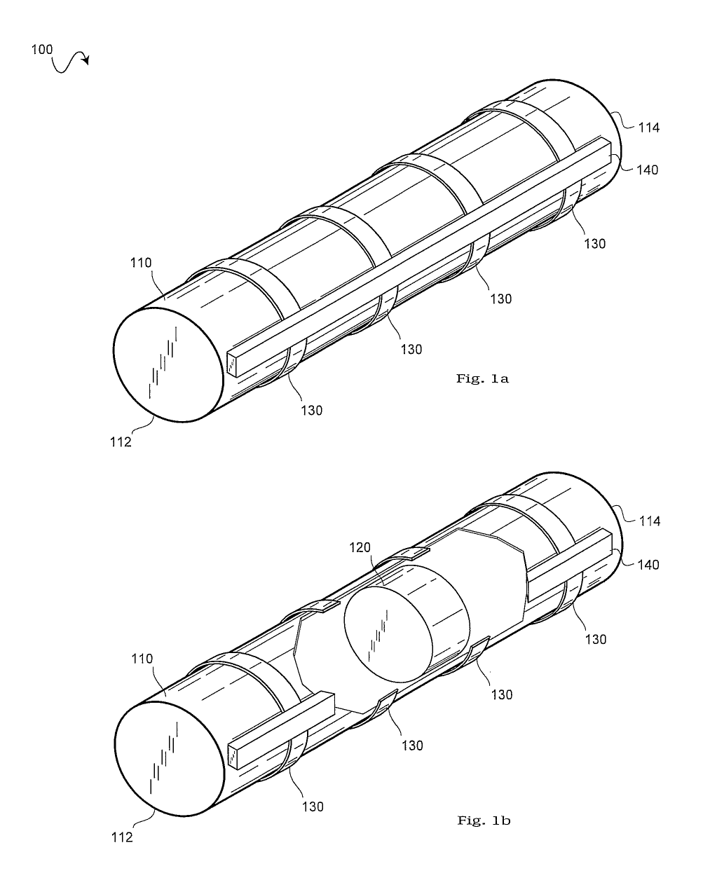

FIG. 1 shows an exemplary embodiment 100 of a power generation system, which may include a tubular member 110, a magnet 120, a plurality of coils 130 and a circuit box 140. The tubular member 110 may be designed to receive a magnet 120. The tubular member 110 may be of any desirable shape and size and may receive any desirable magnet 120. The magnet 120 may also be of any desirable shape and size. For example, the magnet 120 may be a cylindrical magnet with an outer diameter smaller than the inner diameter of the tubular member 110, and a length substantially smaller than the length of the tubular member 110, such that the magnet 120 may slidably engage the tubular member 110. The magnet 120 may be contained within the tubular member 110. The interface between the outside surface of the magnet 120 and the inside surface of the tubular member 110 may be hermetic. The first end 112 and the second end 114 of the tubular member 110 may be sealed, and coils 130 may be disposed on the outside surface of the tubular member 110. The coils 130 may be made of any desirable wire, such as copper wire, or any other conducting material known in the art. Any desirable number of coils 130, of any desirable size, in any desirable configuration may be utilized as the coils which may be disposed outside the tubular member 110. Alternatively, coils may be disposed against the inside surface of a tubular member or within the shell or walls of a tubular member. The coils 130 may be electrically coupled to the circuit box 140.

The tubular member may contain any fluid known in the art. Heat may radiate from the center of the tubular member 110. Either end of the tubular member 110 may be capable of being coupled to a hot or cold point. An attachment may be mechanical, for example, using attached clamps, thermal conduction paste or any attachment means known in the art. Once a coupling is made, the hot and cold ends may be assigned and fixed. For example, the first end 112 may be attached to, placed against or near, or otherwise coupled to any heat source or means known in the art. The second end 114 may be attached to, placed against or near, or otherwise coupled to any cooling source or means known in the art, such as, for example, heat radiating fins or a cooling fan. The first end 112 may then be assigned as the hot end, and the second end 114 may be assigned as the cold end.

Each coil 130 may be thick enough to capture a substantial portion of the magnetic flux created by the moving magnet, in accordance with methods known in the art. Additionally, each coil 130 may be stacked next to an adjacent coil 130 such that the magnet 120 or of the tubular member 110 may be substantially covered by, surrounded by, or filled with coils 130. The coils 130 may be separated by any desirable regular or irregular interval. The intervals may allow heat to radiate away from the power generation system, thus reducing heat buildup at the cold end.

The circuit box 140 may be of any desirable shape. For example, it may be a rectangular box attached to the side of the tubular member, or a collar-shaped container which can fit on the outside of the coils, or any box or container known in the art. One or more circuits within the circuit box 140 may provide power to an external load.

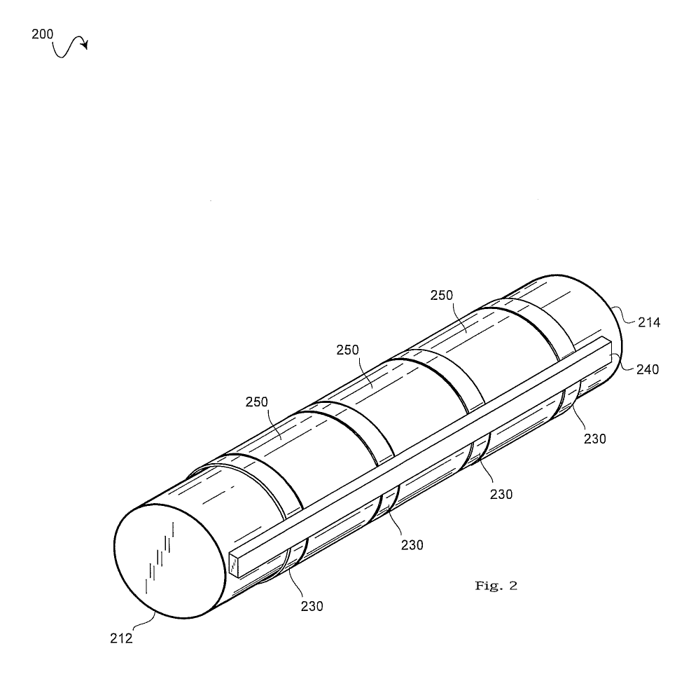

FIG. 2 shows an exemplary embodiment 200 of a power generation system. Many components of embodiment 200 are the same or similar to those of embodiment 100, and are identified by similar numerals. Such components should be understood to have substantially similar characteristics and functionality in both embodiments. As in exemplary embodiment 100, the power generation system in exemplary embodiment 200 may include a tubular member 210, which may be designed to receive a magnet 220, a plurality of coils 230, and a circuit box 240. The first end 212 and the second end 214 of the tubular member 210 may be sealed, and coils 230 may be disposed on the outside surface of the tubular member 210. Exemplary embodiment 200 may further include separators 250.

In exemplary embodiment 200, each coil 230 may be separated from the adjacent coils 230 by a separator 250 made from a material with a thermal coefficient different from that of the coils 230, such as paper, or any other such material known in the art. The combination of the separators 250 and the coils 230 may provide a heat pathway when radiating unwanted heat.

In another exemplary embodiments, a circuit box may be electrically coupled to each coil or more than one coil, and may be used to automatically start the magnet moving within a tubular member. The circuit box may include an auto-starting charger circuit, an auto-starting accelerator circuit, a power generating circuit, or some combination thereof. The circuit box may include a container coupled to the coils. One or more thermocouples may be embedded in, attached to, or otherwise coupled to the tubular member, for example, near or at the ends of the tubular member. The thermocouples may be electrically coupled to the circuit box using wires or any other electrical connection means known in the art. The circuit box may include an internal or external power supply means, as known in the art, for low temperature applications.

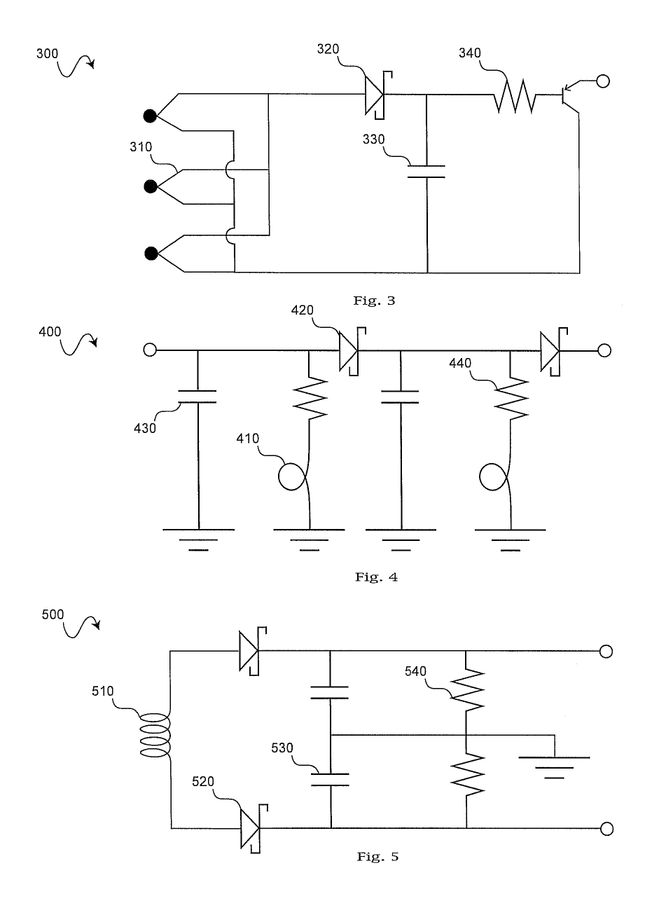

Generally referring to FIGS. 3-5, an auto-starting charger circuit, an auto-starting accelerator circuit, a power generating circuit, or some combination thereof, may be electrically coupled to each coil or more than one coil. If there is a sufficient temperature difference between the ends of the tubular member, a sufficient charge may build to pulse each coil, which may force the magnet to move along the inside of the tubular member. The sufficiency of the charge may depend on systematic and/or environmental factors, such as the mass of the magnet, the heat and electrical conductivity of the components, or any other systematic factors known in the art. The charge may build up using at least one thermocouple. Each coil may be pulsed in succession or simultaneously. A pulse may be produced by a capacitor charged by a thermocouple, or by an internal or external power supply.

FIG. 3 shows an exemplary embodiment of an auto-start charger circuit 300, which may include at least one thermocouple 310, at least one Schottky diode 320, at least one capacitor 330 and at least one resistor 340. The auto start charger circuit may perform at least two functions. The auto start charger circuit may supply a charge to a capacitor 330. The charge may be a trickle charge. Once the capacitor 330 reaches a critical charge, it may supply power to the auto-start accelerator circuit. Alternatively, the auto start charger circuit may detect when a temperature differential exist, using one or more thermocouples 310. A thermocouple 310 may begin sending current to a charging capacitor 330. When a sufficient charge is reached in the capacitor 330, the auto-start accelerator circuit may be activated.

FIG. 4 shows an exemplary embodiment of an auto-start accelerator circuit 400, which may include at least one coil 410, Schottky diodes 420, or any diodes known in the art, capacitors 430 and resistors 440. The auto-start accelerator circuit may send an electrical pulse to at least one coil 410. This may drive the magnet and start the device.

FIG. 5 shows an exemplary embodiment of a power-generating circuit 500, which may include at least one coil 510, Schottky diodes 520, or any diodes known in the art, capacitors 530 and resistors 540, configured as a bridge rectifier circuit. Each half of the circuit may charge a capacitor 522. Capacitors 522 may be connected in parallel to supply power to an external load. The resistance of the load may affect the voltage and current the power generation system can supply.

In some exemplary embodiments, each coil may be dedicated either to generate electricity or to move the magnet contained within the tubular member. Alternatively, each coil may be configured both to generate electricity and to move the magnet.

The system may be tuned for various environments in order to maximize output, efficiency, or any other desirable characteristic. For example, in an environment where the system operates continuously, fewer coils may be needed for auto-starting. In contrast, more coils may be added or dedicated to this function in a low temperature environment and/or non-continuous use.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An electrical power generation system comprising:
a hollow tubular member closed at a first end and a second end;
a magnet disposed within the tubular member;
a plurality of conducting coils disposed on an outside surface of the tubular member;
at least one thermocouple adapted to accumulate a charge so as to induce movement of the magnet within the tubular member; and
at least one circuit box electrically coupled to at least one of the plurality of conducting coils.

2. The electrical power generation system of claim 1, wherein a fluid is contained within the tubular member.

3. The electrical power generation system of claim 1, wherein an interface between an inside surface of the hollow tubular member and an outer surface of the magnet is hermetic.

4. The electrical power generation system of claim 1, wherein the circuit box is adapted to supply power to an external load.

5. The electrical power generation system of claim 1, wherein the first end of the tubular member is positioned near a hot element, and the second end of the tubular member is positioned near a cold element.

6. The electrical power generation system of claim 1, wherein the at least one thermocouple is coupled substantially near at least one of the first end of the tubular member and the second end of the tubular member.

7. The electrical power generation system of claim 1, wherein the plurality of conducting coils spans a substantial portion of the outside surface of the tubular member.

8. The electrical power generation system of claim 1, wherein each of the plurality of conducting coils is positioned substantially adjacent to another of the plurality of conducting coils separated by one of regular intervals and irregular intervals.

9. The electrical power generation system of claim 1, wherein at least one of the plurality of conducting coils is separated from another of the plurality of conducting coils by a separator substantially made from a material with a thermal coefficient different from a thermal coefficient of the plurality of conducting coils.

10. The electrical power generation system of claim 1, wherein each of the at least one circuit box comprises at least one of an auto-starting charger circuit, an auto-starting accelerator circuit, and a power generating circuit.

11. The electrical power generation system of claim 10,
wherein the auto-starting charger includes at least one thermocouple and at least one capacitor, and
wherein the auto-starting charger circuit is adapted to supply a charge to a capacitor and to activate the auto-start accelerator circuit.

12. The electrical power generation system of claim 10,
wherein the auto-starting accelerator circuit is electrically coupled to at least one of the plurality of conducting coils, and
wherein the auto-starting accelerator circuit is adapted to send an electrical pulse to at least one of the plurality of conducting coils.

13. The electrical power generation system of claim 12, wherein the electrical pulse is produced by a capacitor charged by a thermocouple.

14. The electrical power generation system of claim 12, wherein the electrical pulse is produced by one of an internal power supply and an external power supply.

15. The electrical power generation system of claim 10, wherein the power-generating circuit is adapted to charge a capacitor.

16. The electrical power generation system of claim 10, wherein the power-generating circuit is adapted to supply power to an external load.
